(19) United States
(12) Patent Application Publication
(10) Pub. No.: US 2006/0289245 A1
(43) Pub. Date: Dec. 28, 2006

(54) Balancing apparatus for elevator

(75) Inventors: Ikuo Asami, Tokyo (JP); Masashi Miyawaki, Tokyo (JP)

Correspondence Address: FOLEY AND LARDNER LLP;SUITE 500, 3000 K STREET NW, WASHINGTON, DC, 20007, US

(73) Assignee: Toshiba Elevator Kabusshiki Kaisha

(21) Appl. No.: 10/547,290

(22) PCT Filed: Mar. 5, 2005
(86) PCT No.: PCT/JP05/04273

§ 371 Date: Jun. 28, 2006

(30) Foreign Application Priority Data
Mar. 16, 2004 (JP) 2004-075106

(51) Int. Cl. B66B 17/12

(52) U.S. Cl. 187/404

(57) ABSTRACT

A balancing apparatus includes a frame body (1), a first weight (2) and a second weight (3) separated from each other vertically in the frame body (1). The first weight (2) is connected to the frame body (1) through elastic bodies (41, 42). The elastic bodies (41, 42) are always subjected to compression load. The first and second weights (2, 3) are accommodated together in the frame body (1). Since tensional load is not applied to the elastic bodies (41, 42), the durability of the balancing apparatus can be ensured.

### BACKGROUND OF THE INVENTION

1. Technical Field

The present invention relates to the improvement of a balancing method for an elevator.

2. Background Art

In a rope type elevator where an elevator car moves up and down through a main rope wound around a drive sheave, oscillations and vibrations of the car cause the ride quality for passengers to deteriorate.

Until now, various contrivances have been attempted in order to reduce such oscillations and vibrations. For instance, the elevator car is provided with an antivibration apparatus for reducing vibrations in the car.

In the rope type elevator, generally, the elevator car is connected to a balance weight through the main rope. In view of the fact that oscillations and vibrations are transmitted to the car through the main rope, a reduction in oscillations and vibrations of the balance weight are indispensable for an improvement in the ride quality for passengers in the elevator car. Consequently, there has been proposed various measures to reduce the oscillations and vibrations of the balance weight.

A variety of reasons are presumed why such oscillations and vibrations of the balancing apparatus (balance weight) are produced.

Although there is the case in that a change in the weight of the car itself, namely, its load change is transmitted to the balancing apparatus to cause its oscillations and vibrations, the balancing apparatus may oscillate and vibrate due to rotational vibrations of the drive sheave in the traveling course of an elevator, oscillations of the main rope itself, slight expansion movement of the main rope in the longitudinal direction and so on.

Additionally, in a rope type elevator that adopts so-called “one to one (1:1)” roping arrangement, a compensating rope (balancing rope) is interposed between the car and the balancing apparatus, so, oscillations of such a compensating rope may cause the balancing apparatus to oscillate or vibrate.

In any case, as oscillation or vibrations of the balancing apparatus cause the elevator car to vibrate through the intermediary of the main rope, it is required to reduce such oscillation or vibrations of the balancing apparatus.

In order to reduce oscillation or vibrations of the balancing apparatus, Japanese Patent Application Laid-open (Heisei) No. 6-100273 proposes a balancing apparatus as shown in FIG. 1.

In this balancing apparatus, a frame body is divided into a first frame body 1A accommodating a first weight 2 and a second frame body 1B accommodating a second weight 3. The first frame body 1A is connected to the second frame body 1B through elastic bodies 41, 42 (e.g. springs) and a damper 5 juxtaposed to each other. The first frame body 1A is also connected to a plurality of main ropes 7 through corresponding shackle rods 6, while the second frame body 1B is connected to compensating ropes 8.

In the balancing apparatus, the elastic bodies 41, 42 and the damper 5 do constitute a dynamic vibration absorber for suppressing vibrations of the balancing apparatus.

However, the above-mentioned balancing apparatus is complicated in structure due to the existence of the frame bodies 1A, 1B in separation.

Additionally, although the elastic bodies 41, 42 and the damper 5 forming the dynamic vibration absorber exhibit superior durability for withstanding compression load, they exhibit inferior durability for withstanding successive tensional loads.

That is, in the disclosed balancing apparatus where the elastic bodies 41, 42 and the damper 5 suspend the lower frame body 1B containing the second weight 3 and also the compensating ropes 8, the dynamic vibration absorber is usually subjected to tensional loads. Consequently, there is a possibility that the dynamic vibration absorber deteriorates in function in process of time.

### DISCLOSURE OF INVENTION

In the above-mentioned situation, it is an object of the present invention to provide a balancing apparatus for an elevator, which has a simple structure for suppressing vibrations of the balancing apparatus and a dynamic vibration absorber whose function can be maintained in spite of the passage of time.

In order to achieve the above-mentioned object, according to the first aspect of the present invention, a balancing apparatus for an elevator having an elevator car for passengers, comprises: a frame body connected to the elevator car through a main cable; and a balancing weight accommodated in the frame body, the balancing weight having a first weight and a second weight separated from each other vertically in the frame body, wherein the first weight is positioned above the second weight and is supported by the frame body through a dynamic vibration absorber under the first weight.

In the balancing apparatus of the first aspect, since the first weight is connected to the frame body through at least the dynamic vibration absorber, it is always subjected to not tensional loads but compression load.

Accordingly, the durability of the dynamic vibration absorber can be maintained in spite of the process of time. Additionally, since the first weight and the second weight are accommodated together in the single frame body, the structure of the balancing apparatus is simplified and the arrangement of the first and second weights can be maintained irrespective of the durable change of the dynamic vibration absorber.

According to the second aspect of the invention, in the above balancing apparatus, the dynamic vibration absorber includes at least one elastic body.

Then, the dynamic vibration absorber is simplified in structure.

According to the third aspect of the invention, in the above balancing apparatus of the second aspect, the dynamic vibration absorber further includes a damper.

Then, owing to the addition of the damper, the dynamic vibration absorber is enhanced in absorbing vibrations of the balancing apparatus.

According to the fourth aspect of the invention, in the above balancing apparatus of the second aspect, the dynamic vibration absorber includes upper and lower elastic bodies between which the first weight is interposed, and the first weight is connected to the frame body through the upper elastic body.

In the above arrangement, since both of the upper and lower elastic bodies are subjected to compression load, the durability of the dynamic vibration absorber can be maintained in spite of the process of time.

According to the fifth aspect of the invention, in the above balancing apparatus of the fourth aspect, the dynamic vibration absorber further includes a damper juxtaposed to the upper elastic body.

Then, owing to the addition of the damper, the dynamic vibration absorber is enhanced in absorbing vibrations of the balancing apparatus.

According to the sixth aspect of the invention, the balancing apparatus of the second aspect further comprises a sheave rotatably arranged in the frame body, wherein the first weight is connected to the sheave, and either the sheave or the first weight is connected to the frame body through the elastic body arranged on the sheave or the first weight.

With the arrangement mentioned above, since the elastic body is subjected to compression load, the durability of the dynamic vibration absorber can be maintained in spite of the process of time.

According to the seventh aspect of the invention, the balancing apparatus of the third aspect further comprises a sheave rotatably arranged in the frame body, wherein the first weight is connected to the sheave, and either the sheave or the first weight is connected to the frame body through the elastic body arranged on the sheave or the first weight and the damper juxtaposed to the elastic body.

Also in this case, owing to the addition of the damper, the vibration absorbing function of the dynamic vibration absorber can be enhanced.

According to the eighth aspect of the invention, in the balancing apparatus of the first aspect to the seventh aspect, at least one of the first weight or the second weight is formed by a lamination of weight members.

Then, by changing the number of weight members, the first weight or the second weight can be modified in terms of weight.

According to the ninth aspect of the invention, the balancing apparatus of the first aspect to the eighth aspect further comprises a slide member or a rotating member interposed between the frame body and the first weight and movable either up or down due to expansion and contraction of the dynamic vibration absorber.

Then, owing to the interposition of the slide member or the rotating member, the first weight can slide in the frame body with no inclination.

These and other objects and features of the present invention will become more fully apparent from the following description and appended claims taken in conjunction with the accompanying drawings.

### BRIEF DESCRIPTION OF DRAWINGS

FIG. 1 is a structural view of a conventional balancing apparatus;

FIG. 2 is a structural view of a balancing apparatus in accordance with the first embodiment of the present invention;

FIG. 3 is a sectional view taken along a line 3-3 of FIG. 2;

FIG. 4 is a structural view of the balancing apparatus of FIG. 1, showing an arrangement adopting other fixing elements;

FIG. 5 is a structural view of the balancing apparatus of FIG. 1, showing a state where the vertical arrangement of the first and second weights is reversed;

FIG. 6 is a structural view of a balancing apparatus in accordance with the second embodiment of the present invention; and

FIG. 7 is a structural view of a balancing apparatus in accordance with the third embodiment of the present invention.

### BEST MODE FOR CARRYING OUT THE INVENTION

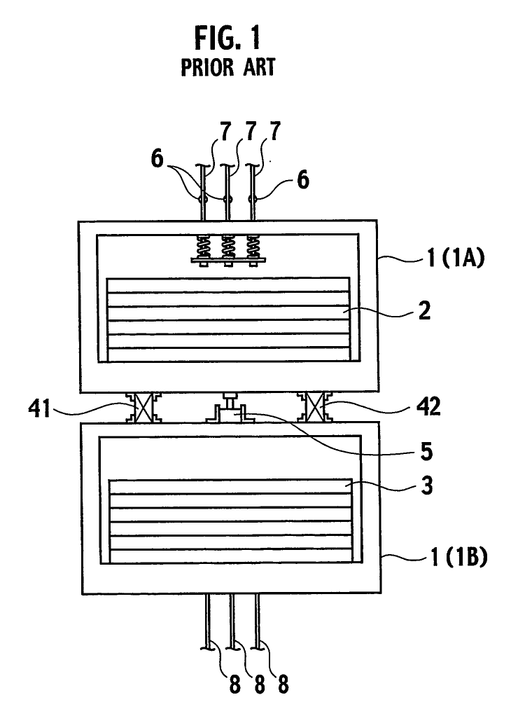

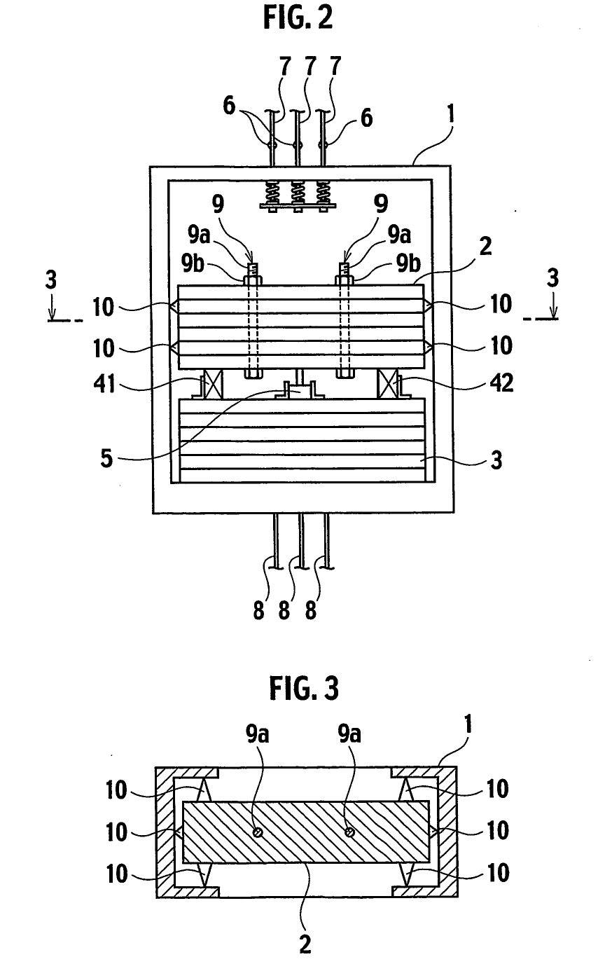

Referring to FIGS. 2 to 7, embodiments of the present invention will be described below. Note, that elements identical to those of the conventional balancing apparatus of FIG. 1 are indicated with the same reference numerals respectively.

FIG. 2 is a structural view of a balancing apparatus applied to a one-to-one roping type elevator. FIG. 3 is a sectional view taken along a line 3-3 of FIG. 2.

According to the first embodiment, the balancing apparatus includes one frame body 1, first and second weights 2, 3 both accommodated in the frame body 1 vertically, elastic bodies 41, 42 and a damper 5 all interposed between the first weight 2 and the second weight 3.

As shown in FIG. 2, each of the first and second weights 2, 3 contains a plurality of plate-shaped weight members, such as metal plates, stacked upon each other. The elastic bodies 41, 42 are formed together by elastic members, for example, coil springs, rubbers and so on.

The elastic bodies 41, 42 and the damper 5, which are juxtaposed horizontally to form a dynamic vibration absorber, are positioned on the second weight 3 to support the first weight 2 thereon. The second weight 3 is fixed onto the frame body 1. Thus, the elastic bodies 41, 42 and the damper 5 are adapted so as to support a load of the first weight 2 and are always subjected to compressive pressure.

In the one-to-one roping type elevator shown in the figure, the frame body 1 is suspended from main ropes 7 through shackle rods 6, while dynamic vibration absorber compensating ropes 8 drag a lower part of the frame body 1 downwardly due to their own weights.

The above-constructed balancing apparatus operates as follows.

If the balancing apparatus oscillates or vibrates by various causes (e.g. oscillations or vibrations of the car or the main ropes 7, rattling movement of a not-shown drive sheave in rotation occurs, causing a slight expansion and contraction of the main ropes 7, etc.), then the first weight 2 vibrates vertically. However, as the elastic bodies 41, 42 and the damper 5 forming the dynamic vibration absorber function to absorb or suppress such vibrations of the first weight 2, vibrations of the whole balancing apparatus is alleviated, so that vibrations of the car can also be suppressed.

As shown in the figure, the first weight 2 is formed by a lamination of metal plates. In order to maintain such a lamination in spite of vibrations of the first weight 2 itself, it is secured by fixing elements 9. Each of the fixing element 9 is a type of securing unit having a bolt 9a penetrating the first weight 2 and a nut 9b in thread engagement with the bolt 9a.

According to the first embodiment, as shown in FIG. 3, the first weight 2 swinging vertically is provided, on all sidewalls thereof, with slide members 10 in the form of triangular pyramids. These slide members 10 are arranged in a manner that their respective tips come in soft contact with the inside wall of the frame body 1. With the arrangement of the slide members 10, the first weight 2 is capable of smoothly sliding in the vertical direction with no inclination while being guided by the frame body 1. That is, when the whole balancing apparatus vibrates and consequently, the first weight 2 oscillates up and down in a direction to cancel the vibrations of the balancing apparatus, the first weight 2 is capable of stable movement in the vertical direction without being inclined

Note that in the balancing apparatus, its frequency and amplitude of vibration is generally determined by the lengths of the main ropes 7 between the drive sheave and the balancing apparatus and its weight (mass) thereof. Meanwhile, in the balancing apparatus of the first embodiment, when the apparatus itself vibrates, the dynamic vibration absorber formed by the elastic bodies 41, 42 and the damper 5 functions to cancel vertical oscillation of the first weight 2, that is, its vibration. Therefore, it is possible to avoid the occurrence of unnecessary secondary vibration of the apparatus itself.

With regard to the weight ratio of the first weight 2 to the whole weights, respective spring constants of the elastic bodies 41, 42 and the damper 5 and their elastic coefficients, there are selected appropriate values that allow the vibration frequency, which has the largest energy in the vibration mode of the whole balancing apparatus, to be absorbed or restricted within a wider frequency range effectively.

Additionally, according to the first embodiment, as the first weight 2 is formed by a lamination of metal plates etc., it is possible to properly select a ratio of the first weight 2 to the whole weight in view of more effective antivibrating or damping action.

As mentioned above, the balancing apparatus of the first embodiment has a simple structure where the first and second weights 2, 3 are arranged up and down in the single frame body 1 while interposing the juxtaposed elastic bodies 41, 42 and the damper 5 therebetween. Furthermore, the elastic bodies 41, 42 and the damper 5 are always subjected to compressive load due to the first and second weights 2, 3. Accordingly, it is possible to afford a high level of safety and appropriate durability for the elevator.

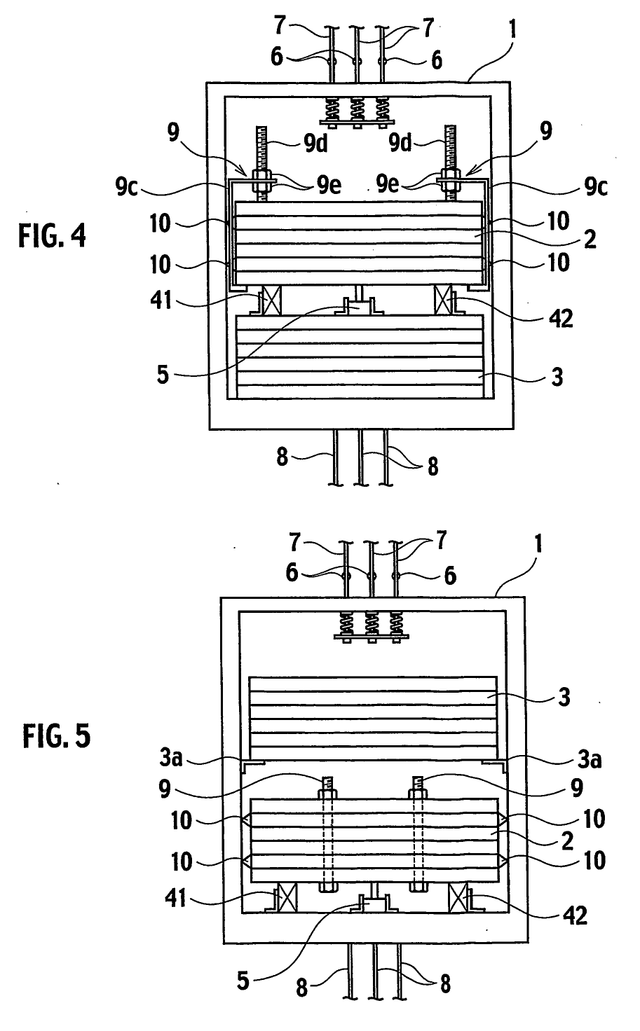

Note that although the fixing element 9 is formed by the bolt 9a and the nut 9b in the first embodiment, the constitution may be modified as shown in FIG. 4. In this modification, the fixing element 9 is formed by a U-shaped retainer attachment 9c, a pusher screw rod 9d penetrating the upper end of the retainer attachment 9c and a pair of nuts 9e, 9e for fixing the rod 9d on the upper end of the retainer attachment 9c.

The arrangement where the elastic bodies 41, 42 and the damper 5 are arranged on the second weight 3 may be modified. It follows that a similar effect can be expected if only arranging the elastic bodies 41, 42 and the damper 5 on a structure integral with the frame body 1. In the modification shown in FIG. 5, the elastic bodies 41, 42 and the damper 5 are mounted on the inside bottom wall of the frame body 1 directly. With this arrangement, the second weight 3 is arranged above the first weight 2 and also fixed to the frame body 1 through attachment elements 3a, 3a.

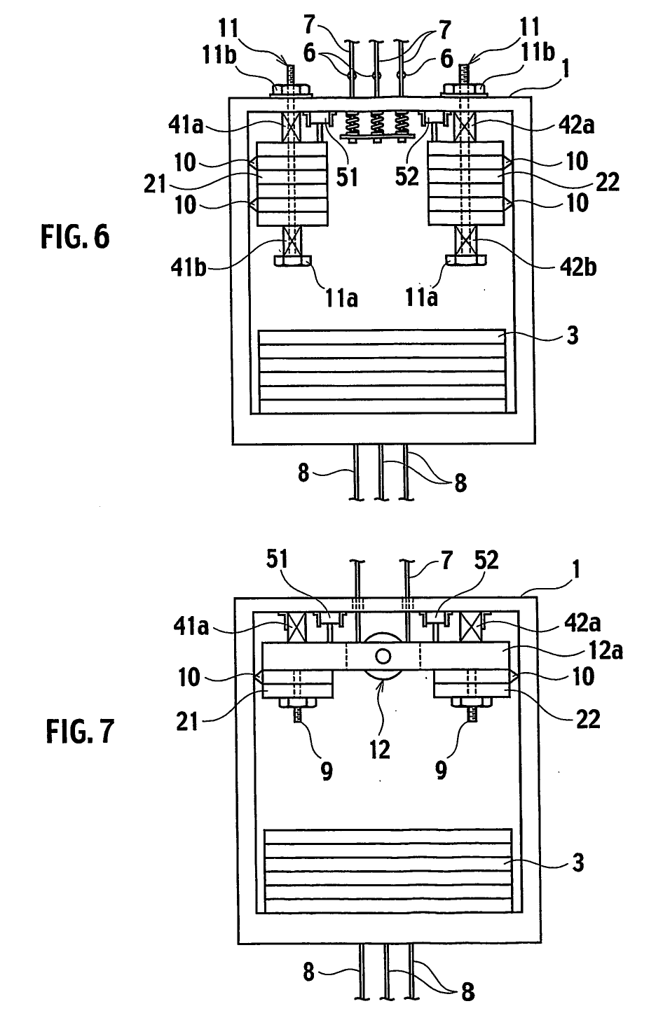

The second embodiment will be described with reference to FIG. 6.

The following descriptions are directed to differences in the second embodiment from the first embodiment of FIGS. 2 to 5.

In the balancing apparatus of FIG. 6, the above first weight 2 is divided into two group of weights from side to side. That is, first weights 21, 22 are arranged so as to avoid the shackle rods 6 at the center of the upper part of the frame body 1. Being interposed between a first elastic body 41a and a second elastic body 41b in the vertical direction, the first weight 21 is connected to the frame body 1 through the first elastic body 41a. Similarly, being interposed between another first elastic body 42a and another second elastic body 42b in the vertical direction, the first weight 22 is connected to the frame body 1 through the first elastic body 42a. The first elastic bodies 41a, 42a and the second elastic bodies 41b, 42b are always subjected to pressures from the frame body 1 and the first weights 21, 22.

For the above arrangement, two bolts 11a, 11a are arranged so as to penetrate the first weights 21, 22 and the frame body 1. On the upper part of the frame body 1, nuts 11b, 11b are fastened to the bolts (parts) 11a, 11a projecting from the frame body 1.

Further, dampers 51, 52 forming the dynamic vibration absorber are arranged in parallel with the first elastic bodies 41a, 42a, respectively. Between the first weights 21, 22 and the frame body 1, the dampers 51, 52 are also subjected to pressures.

Thus, also in the second embodiment, the first and second weights 21, 22, 3 are arranged up and down in the frame body 1. Further, the elastic bodies 41a, 41b, 42a, 42b and the dampers 51, 52, which form the dynamic vibration absorber are always under pressure, function to absorb or suppress vibrations of the first weights 21, 22 vibrating in association with the vertical vibration of the apparatus itself. Owing to such an operation of the apparatus, it is possible to restrict the vibration of the whole apparatus effectively and stably.

Although no slide member is provided on opposing sidewalls of the first weight 21, 22 of the second embodiment, the bolts 11a, 11a penetrating the weights 21, 22 are fixed to the frame body 1 in alternation. Therefore, it is possible to prevent the first weights 21, 22 from oscillating from side to side largely.

Here, note that the first and second embodiments are commonly related to the balancing apparatus for a rope type elevator adopting a one-to-one (1:1) roping arrangement. Additionally, the present invention is applicable to a rope type elevator adopting two-to-one (2:1) arrangement.

Accordingly, FIG. 7 shows the third embodiment where the balancing apparatus is applied to such an elevator adopting a two-to-one (2:1) arrangement.

According to the third embodiment, the frame body 1 is provided, therein, with a sheave 12 around which the main rope 7 is wound. The sheave 12 is rotatably supported by a plate 12a. The first weights 21, 22 similar to those of the second embodiment are fixed onto the lower surface of the plate 12a through the fixing elements 9, symmetrically.

Similar to the second embodiment, the first and second weights 41a, 42a are disposed between the upper surface of the plate 12a and the upper part of the frame body 1, corresponding to the first weights 21, 22 respectively. Additionally, the dampers 51, 52 are juxtaposed to the elastic bodies 41a, 42a, respectively. The dynamic vibration absorber is formed by the elastic bodies 41a, 42a and the dampers 51, 52.

Also in the third embodiment, the first and second weights 21, 22, 3 are arranged up and down in the frame body 1. Further, since the first weights 21, 22 are adapted so as to always apply pressure onto the elastic bodies 41a, 42a and the dampers 51, 52, it is possible to accomplish stable vibration-absorbing and damping effects, similar to the first and second embodiments.

In the modification, so long as the first weights 21, 22 form one body with the plate 12a, these weights 21, 22 may be mounted on the upper surface of the plate 12a. In such a case, the dynamic vibration absorber is arranged between the first weights 21, 22 and the frame body 1.

In common with the above-mentioned embodiments, the dynamic vibration absorber is formed by the elastic bodies 41, 41a, 41b, 42, 42a, 42b and the dampers 5, 51, 52. Alternatively, upon deletion of the dampers, the dynamic vibration absorber may be formed by the elastic bodies 41, 42 (or 41a, 42a) only although the range of frequency of absorbed vibration is somewhat lessened.

Additionally, so long as the first weight 2 is allowed to oscillate vertically and smoothly, the above slide members 10 may be formed by rectangular solids in place of triangular pyramids in the shown embodiments. Alternatively, for the same reason, rotatable wheels (not shown) in place of the slide members 10 may be attached to either the frame body 1 or the first weight 2.

Finally, it will be understood by those skilled in the art that the foregoing descriptions are nothing but three embodiments of the disclosed balancing apparatus and therefore, various changes and modifications may be made within the scope of the claims.

### INDUSTRIAL APPLICABILITY

In the balancing apparatus of the present invention, since the first weight is connected to the frame body through at least the dynamic vibration absorber, it is always subjected to not tensional loads but compression load. Accordingly, the durability of the dynamic vibration absorber can be maintained in spite of the process of time. Additionally, as the first weight and the second weight are accommodated together in the single frame body, the structure of the balancing apparatus is simplified and the arrangement of the first and second weights can be maintained irrespective of the durable change of the dynamic vibration absorber.

1. A balancing apparatus for an elevator having an elevator car for passengers, comprising:
a frame body connected to the elevator car through a main cable; and
a balancing weight accommodated in the frame body, the balancing weight having a first weight and a second weight separated from each other vertically in the frame body, wherein
the first weight is positioned above the second weight and is supported by the frame body through a dynamic vibration absorber under the first weight.

2. The balancing apparatus of claim 1, wherein the dynamic vibration absorber includes at least one elastic body.

3. The balancing apparatus of claim 2, wherein the dynamic vibration absorber further includes a damper.

4. The balancing apparatus of claim 2, wherein
the dynamic vibration absorber includes upper and lower elastic bodies between which the first weight is interposed, and
the first weight is connected to the frame body through the upper elastic body.

5. The balancing apparatus of claim 4, wherein
the dynamic vibration absorber further includes a damper juxtaposed to the upper elastic body.

6. The balancing apparatus of claim 2, further comprising a sheave rotatably arranged in the frame body, wherein
the first weight is connected to the sheave, and
either the sheave or the first weight is connected to the frame body through the elastic body arranged on the sheave or the first weight.

7. The balancing apparatus of claim 3, further comprising a sheave rotatably arranged in the frame body, wherein
the first weight is connected to the sheave, and
either the sheave or the first weight is connected to the frame body through the elastic body arranged on the sheave or the first weight and the damper juxtaposed to the elastic body.

8. The balancing apparatus of claim 1, wherein at least one of the first weight and the second weight is formed by a lamination of weight members.

9. The balancing apparatus of claim 1, further comprising a slide member or a rotating member interposed between the frame body and the first weight and able to be moved up and down due to expansion and contraction of the dynamic vibration absorber.
